(19) United States
(12) Patent Application Publication
(10) Pub. No.: US 2004/0244267 A1
(43) Pub. Date: Dec. 9, 2004

(54) Fishing lure and tackle wrapper and holder

(76) Inventor: Benjamin Wilbur Kiehl JR., New Baltimore, MI (US)

Correspondence Address: BENJAMIN W. KIEHL JR., 52926 SEQUOIA TRAIL, NEW BALTIMORE, MI, 48047, US

(21) Appl. No.: 10/751,357

(22) Filed: Jan. 6, 2004

Related U.S. Application Data
(60) Provisional application No. 60/320,127, filed on Apr. 21, 2003.

(51) Int. Cl. A01K 87/00

(52) U.S. Cl. 43/25.2

(57) ABSTRACT

A fishing lure wrapper consisting of a flexible panel of material with an outer layer of cloth or flexible cover and an inner layer of hook and latch material (e.g. velcro) to receive fishing lures for the purpose of protection of the hooks and/or storage. Also, the lure protector may be folded about a fishing rod to secure the bait in position for immediate use whenever desired, and to prevent fouling and entanglement of nearby gear in a fishing boat, auto or the like.

This application claims priority of prior application Ser. No. 60/320,127 filed Apr. 21,2003.

This invention relates to new and useful improvements in fishing gear, and has particular reference to a device for protecting fishing lures and other fishing tackle from entanglement with itself and/or the surrounding environment like clothing, car seats, boat cushions etc.

Many fishermen, particularly serious or professional fishermen, commonly equip themselves with several fishing rods on any fishing trip, each fitted with a different lure or bait adapted for use with a different species of fish he may encounter, or for which he may intend to fish. He of course desires to have the lure equipped rods available for almost instantaneous use whenever desired.

The present invention has as its object the provision of a lure wrapping device which will keep it from getting tangled or hooked into unwanted surfaces such as car seats, head liners, clothing etc. Generally, this object is accomplished by the provision of a lure wrapper comprising a two-leaf folder having a cover sheet of flexible material (e.g. canvas or felt) or panel and a liner layer of hook and latch material (e.g. Velcro). When closed about a fishing lure or fishing tackle, the wrapper renders the hooks harmless and tangle free. The folder should be of sufficient area to enclose the lure and its associated hooks and/or fishing tackle. The hook and latch material layer may be sufficiently deep that it will form itself snugly about the lure or fishing tackle to keep it firmly captured and protected. If the lure is attached to the line of a fishing rod, which is desirable and customary, the folder may also be positioned to include the fishing rod therein, so that the entire assembly of rod, line, and lure may be readied for immediate use simply by opening and removing the wrapper.

Other objects are simplicity and economy of construction, efficiency and dependability of operation, and ease and convenience of use.

With these objects in view as well as other objects which will appear in the course of the specification, reference will be had to the accompanying drawing, wherein:

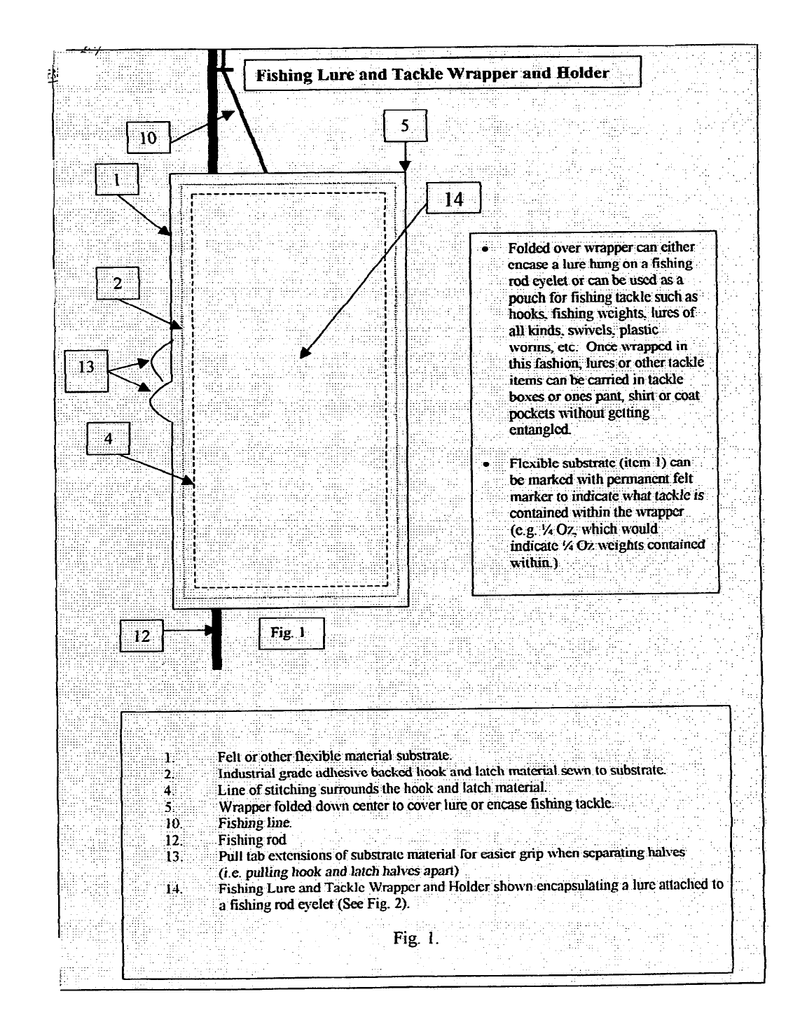

FIG. 1 is view of a fragmentary elevational view of a fishing rod, showing a fishing lure and tackle wrapper and holder embodying the present invention applied operatively thereto,

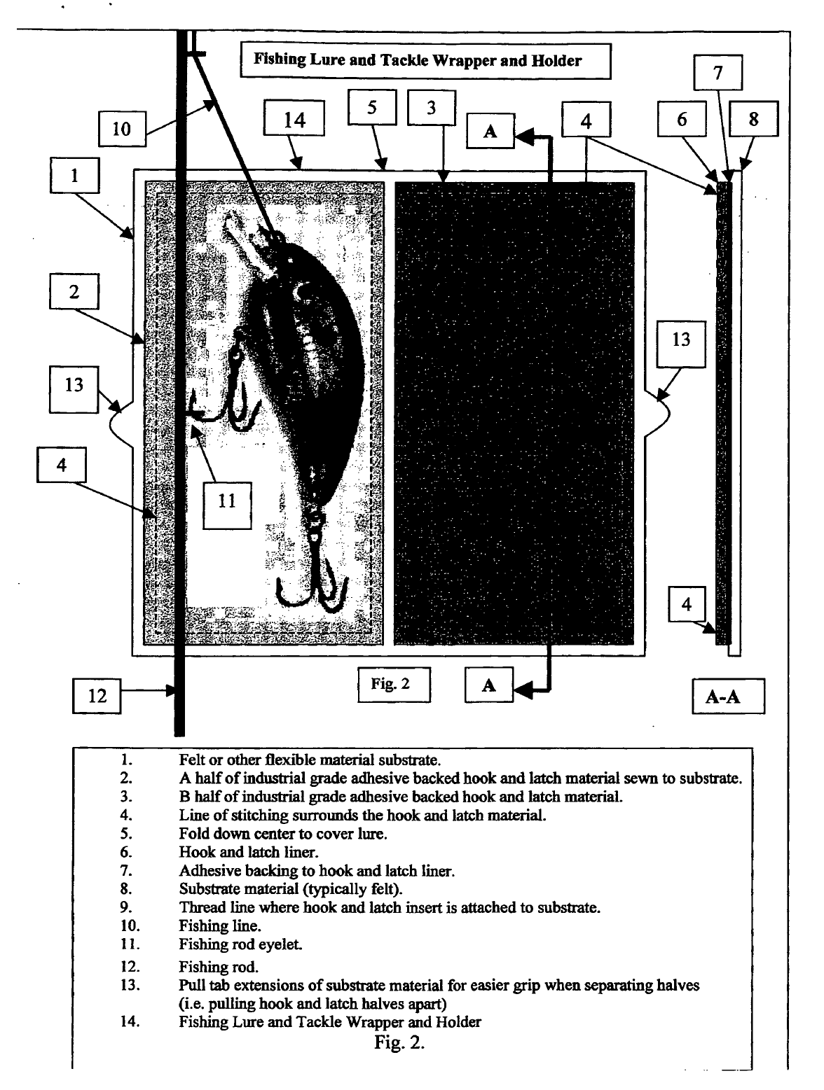

FIG. 2 is a plan view and sectional side view taken on line AA of FIG. 2.,

Like reference numerals apply to similar parts throughout the several views, and the numeral 14 applies generally to a Fishing Lure and Tackle Wrapper and Holder embodying the present invention. Said wrapper and holder consists of a folder shown as generally rectangular, although its shape is optional, having an outer or cover layer 1 of a thin, pliable, cloth or waterproof material such as vinyl, and an inner layer or liner 2 and 3 of industrial grade, adhesive backed hook and latch fastening material (e.g. Velcro). Said liner is relatively thick as compared to the cover, and is of nearly the same area as the cover, coinciding therewith. Both the cover and the liner are formed of materials which are not deteriorated by water.

Velcro is a well known fastener consisting of a fabric or other flexible base in which are affixed projecting hooked strands of a relatively stiff material. When two such members are pressed together, the hooked strands interengage to hold the members firmly together, although they may readily again be separated by the application of substantial manual separating force, and may be repeatedly rejoined and separated.

In use, the folder 14 is laid out flat as shown in FIG. 2, and a lure, hooked to an eyelet of a fishing rod by one of its treble hooks and held in place by tension being applied to the rods fishing line attached to the lure, is placed at the center of the folder. Then, with the lure and its treble hooks arranged along the center of the protector folder, the protector is wrapped around the lure, its attached fishing line and the fishing rod to which it is attached as shown in FIG. 1, and the folder closed, with the lure and fishing rod included therein as shown in FIG. 1, and secured closed by pressing the then confronting surfaces of the hook and latch material (Velcro) inner liner 2 and 3 firmly together.

The fishing lure, such as that shown on FIG. 2, could of course be stored and protected in the wrapper shown when not attached to a fishing rod, and in such cases the wrapper could serve merely as a “bait box” holder for such lures or other fishing tackle until use thereof is desired. Also, the wrapper need not be secured around the fishing rod, as shown in FIG. 1, if this is not desired. However, the illustrated and described use, with the lure secured to the fishing line, and the folder secured about the fishing rod to secure the lure against possible fouling with other gear, is believed to be the most advantageous, in that it maintains the entire combination of rod, line, hook and bait in constant readiness for virtually instantaneous use, the only preparation required being the removal of the protector folder.

While I have shown and described a specific embodiment of my invention, it will be readily apparent that many minor changes of structure and operation could be made without departing from the spirit of the invention.

I claim as new and desire to protect by Letters Patent is:

1. A fishing lure wrapper and tackle holder comprising:
a. a panel of flexible material with two inner liners comprised of industrial grade adhesive backed hook and latch material (e.g. Velcro); the companion pieces of the hook and latch material separated at the center so that when the panel is folded upon itself the “Velcro” will lock onto itself sealing the folded panel of material against itself such that it will be able to encapsulate entirely a fishing lure or other fishing gear placed between the liners within the folded panel of material.

2. A fishing lure and tackle wrapper and holder as recited in claim 1 wherein said folded panel constitutes the leaves of a two-leaf folder, said folder having an outer cover layer of flexible material, whereby said folder may be opened and closed in the manner of a book, and an inner liner layer of industrial grade adhesive backed hook and latch material (e.g. Velcro), configured in such a means as to join the two halves of the folded panel.

3. A fishing lure and tackle wrapper and holder as recited in claim 2 wherein said cover layer is formed of varying sorts of cloth or other flexible material as desired and said inner liner layer is formed of industrial grade, adhesive backed hook and latch material (e.g. Velcro), such that when the wrapper is folded upon itself it locks upon itself such that it restricts the volume of said folder as to encapsulate and hold closely around said fishing lure or tackle as may be desired.

4. A fishing lure and tackle wrapper and holder as recited in claim 3 wherein said fastening means is operable to join the two halves of the folded cloth or otherwise flexible material panel together across the entire area of the folder formed thereby.

5. A fishing lure wrapper as recited in claim 4 wherein said fastening means comprises of strips of industrial grade adhesive backed hook and latch material (e.g. Velcro) secured to the entire area of the mating surface of said folded panel by stitching and adhesive backing of the hook and latch material (e.g. Velcro) strips described in claim 4.
